(19) United States
(12) Patent Application Publication
(10) Pub. No.: US 2012/0167326 A1
(43) Pub. Date: Jul. 5, 2012

(54) Wiper Blade for Cleaning Windows of Motor Vehicles and Wiper Arm

(75) Inventors: Bruno Egner-Walter, Heilbronn (DE); Michael Schäuble, Vahingen/Enz (DE)

(73) Assignee: VALEO SYSTEMES D'ESSUYAGE, La Verriere (FR)

(21) Appl. No.: 13/338,495

(22) Filed: Dec. 28, 2011

(30) Foreign Application Priority Data
Dec. 29, 2010 (DE) 10 2010 056 366.8

(51) Int. Cl. B60S 1/40; B60S 1/46

(52) U.S. Cl. 15/250.01; 15/250.32

(57) ABSTRACT

A wiper blade for cleaning windows of motor vehicles, with an adapter for fastening the wiper blade on a wiper arm, wherein the adapter consists of an adapter element on the wiper arm side and of an adapter element on the wiper blade side, which are arranged so as to be pivotable with respect to each other, and wherein the adapter element on the wiper arm side is connected together with the wiper arm via a detent connection. Provision is made that the adapter has at least one support surface for an auxiliary element, which serves for separating the adapter from the wiper arm.

### BACKGROUND

### Prior Art

The invention relates to a wiper blade for cleaning windows of motor vehicles in accordance with the introductory clause of Claim 1. The invention further relates to a wiper arm for connection with a wiper blade according to the invention in accordance with the introductory clause of the independent claim.

A wiper blade according to the introductory clause of Claim 1 is known from DE 10 2008 021 457 A1 of the applicant. The wiper blade is connected with the wiper arm via an adapter so as to be lockable or respectively releasable. Furthermore, the wiper blade has ducts for supply with a washing fluid, which are connected via at least one hose line, guided or respectively arranged in the wiper arm, with a storage container for the washing fluid. The connection of the at least one hose line in the wiper arm to the adapter in the wiper blade takes place here in practice by means of a connection fixedly arranged in the wiper arm, which on mounting of the wiper blade on the wiper arm is coupled with the connections for the washing fluid which are arranged in the adapter.

Furthermore, wiper blades are already known from the patent literature, which in addition to the mentioned possibility of supplying the wiper blade with washing fluid, are constructed as heatable wiper blades, wherein in the adapter of the wiper blade a connecting plug is arranged, which is contacted electrically with a mating plug arranged in the wiper arm. Here, also, the coupling of the two plugs takes place by reciprocal moving of the adapter or respectively of the wiper blade to the wiper arm.

The mentioned hydraulic and electrical connections with the sealing measures which are necessary for this have the result that on changing a wiper blade, the connections must be released from each other axially, which owing to the sealing measures entails a relatively great expenditure of force. This makes the change difficult, in particular in the case of persons who have not expected this relatively great expenditure of force and hence assume that there is defect in the wiper arm or respectively wiper blade.

### SUMMARY OF THE INVENTION

Proceeding from the illustrated prior art, the invention is based on the problem of further developing a wiper blade for cleaning windows of motor vehicles in accordance with the introductory clause of Claim 1 such that it is suited to making possible a simplified dismantling of the wiper blade and, if applicable, a simplified mounting from or respectively on the wiper arm. This problem is solved in a wiper blade for cleaning windows of motor vehicles with the features of Claim 1. The invention is based here on the idea, through the provision of at least one support surface on the adapter of the wiper blade, of forming an engagement surface for an auxiliary element, which serves for the separating of the adapter from the wiper arm. In particular, the said auxiliary element can serve to distinctly reduce the dismantling force necessary for releasing the wiper blade from the wiper arm.

Advantageous further developments of the wiper blade according to the invention for cleaning windows of motor vehicles are indicated in the subclaims. All combinations of at least two of the features disclosed in the claims, in the description and/or in the figures fall within the scope of the invention.

In a first structural implementation of the invention, it is proposed that the support surface is arranged in the region of an end face of the adapter and is constructed as a flat surface. Such an arrangement or construction requires a minimal additional manufacturing expenditure for the adapter and is particularly space-saving, so that the overall size of the adapter does not change substantially.

In an alternative embodiment of the invention, provision is made that the support surface is constructed in the form of a toothing, into which a counter-toothing of the auxiliary element rolls. Such a construction has particularly low friction or respectively has a particularly low wear on the support surfaces.

In a further alternative embodiment of the invention, provision is made that the support surface is constructed as an axis, into which the auxiliary element engages in a form-fitting manner. Such an embodiment also has particular low friction and low wear.

In a further structural embodiment, it is proposed that the at least one support surface is arranged on the adapter element on the wiper blade side. This makes it possible that in the operating position of the wiper blade, in which the wiper blade lies in particular against the window of the motor vehicle, the auxiliary element is not arranged in engagement or respectively in operative connection with the adapter. Rather, the auxiliary element which is arranged on the wiper arm only cooperates with the adapter when the adapter element on the wiper blade side is pivoted to the adapter element on the wiper arm side, wherein this pivoting is known to the operator as the dismantling position.

The invention also comprises a wiper arm for connecting with a wiper blade according to the invention, wherein the wiper arm is releasably connected with the wiper blade via a detent connection. Here, provision is made according to the invention that the auxiliary element is constructed as a pivoted lever which is pivotably mounted on the wiper arm and which, with a contact element for removing the wiper blade from the wiper arm is arranged in operative connection with the at least one support surface.

It is quite particularly preferred here if the pivoted lever is constructed as a gear with a power transmission. Thereby, the dismantling forces for releasing the wiper blade from the wiper arm are reduced in a desired manner.

In order to avoid an unintentional actuating of the pivoted lever, in particular in the operating position of the wiper blade, it is, furthermore, particularly advantageous if the pivoted lever in its one end position, which in particular corresponds to the operating position of the wiper arm, is able to be locked with the wiper arm or with the wiper blade.

Further advantages, features and details of the invention will emerge from the following description of preferred example embodiments and with the aid of the drawings.

### BRIEF DESCRIPTION OF THE DRAWINGS

FIG. 1 a perspective view of a wiper device consisting of a wiper blade and a wiper arm,

FIG. 2 an adapter, used with the wiper blade according to FIG. 1, in individual representation in context with the end region of the wiper arm in a position distant from each other, in perspective view,

FIG. 3 an illustration, partially in section, of the parts according to FIG. 2 to illustrate the hydraulic connection between adapter and wiper arm,

FIG. 4 a pivoted lever for releasing the wiper blade from the wiper arm in a perspective individual representation,

FIG. 5 a longitudinal section in the region of the adapter in the operating position of the wiper blade to illustrate the arrangement of pivoted lever and adapter,

FIG. 6 a simplified illustration of an alternative embodiment of the pivoted lever with a toothing in side view and

FIG. 7 a further alternative embodiment of the invention, in which the pivoted lever cooperates with the adapter of the wiper blade via a bent lever.

Identical components or respectively components having an identical function are provided with the same reference numbers in the figures.

### DETAILED DESCRIPTION OF THE PREFERRED EMBODIMENT(S)

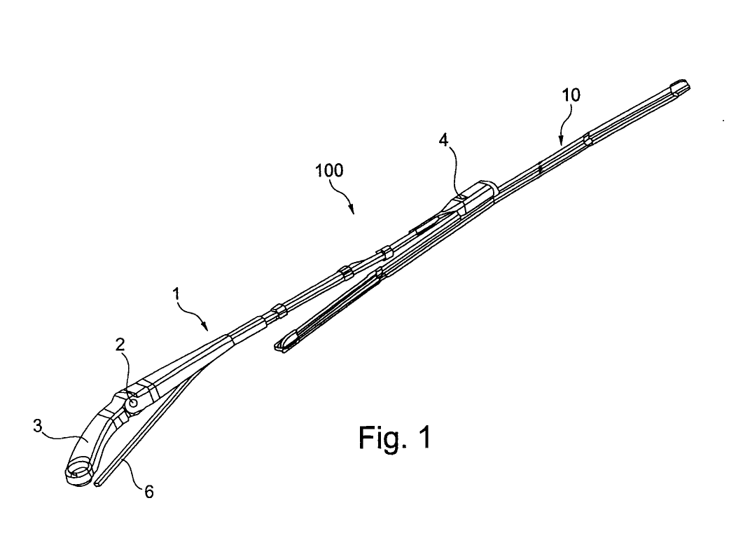

In FIG. 1 a wiper arm 1 and a wiper blade 10 of a wiper device 100 are illustrated, as they serve for cleaning windows of motor vehicles.

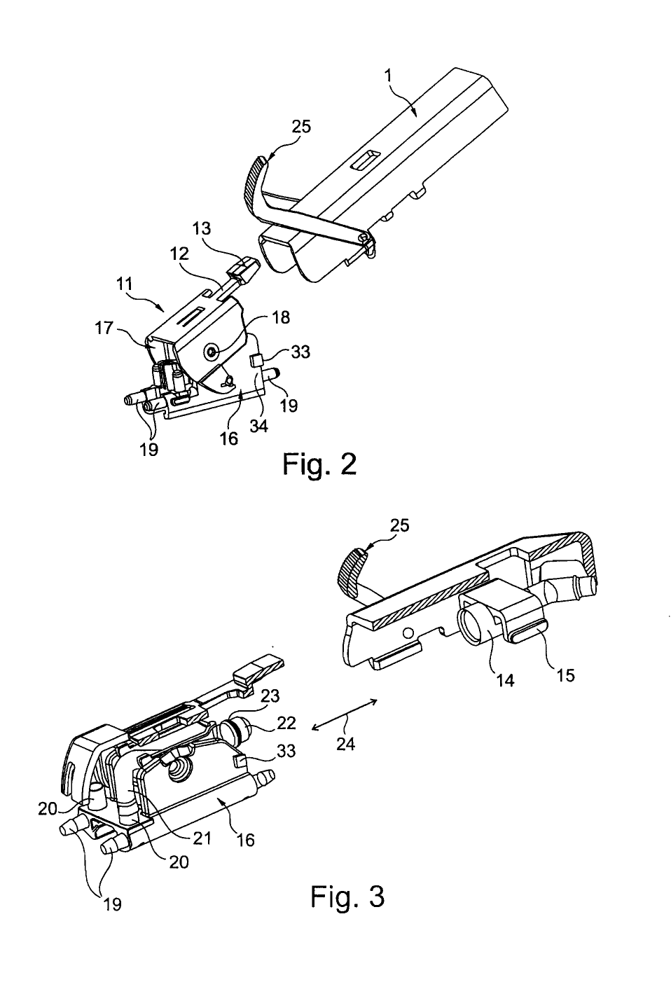

The wiper device 100 comprises in a conventional manner a bearing element 3, connected via a wiper arm joint 2, which bearing element is mounted in a torque-proof and pivotable manner in an axis of a windscreen wiper drive which is not illustrated. The wiper arm 1 has at its end lying opposite the bearing element 3 a U-shaped cross-section, which serves for fastening the wiper blade 10 via an adapter 11 arranged on the wiper blade 10. Here, in the connecting region with the adapter 11 the wiper arm 1 has an opening 4, into which a lever 12, arranged on the adapter 11, engages in a form-fitting manner in the operating position of the wiper device 100 with its detent section 13 (see FIG. 2). The opening 4 therefore forms together with the detent section 13 a detent connection between the wiper arm 1 and the wiper blade 10, which serves for securing the wiper blade 10 on the wiper arm 1 on operation of the wiper device 100.

In addition, with the aid of FIG. 1 at least one hose line 6 can be seen for the supply of washing fluid to the wiper blade 10. The hose line 6 is connected here on the one hand with a washing medium storage container of the motor vehicle, and on the other hand with a hydraulic connecting piece 14 which can be seen in FIG. 3, wherein the hydraulic connecting piece 14 is arranged fixedly in the wiper arm 1 via a holder 15.

Optionally, provision can be made that additionally or else alternatively to the hose line 6, an electric connecting line is provided for the wiper blade 10, via which a heating device, which is not illustrated, in particular in the form of a heating foil, arranged in the wiper blade 10, is supplied with current. Such an electrical connecting line has a first electric connecting plug here, which in analogy to the hydraulic connecting piece 14 is arranged in the holder 15.

As can be seen in particular with the aid of FIG. 2, the adapter 11 of the wiper blade 10 consists of an adapter element 16 on the wiper blade side and of an adapter element 17 on the wiper arm side, which are arranged so as to be pivotable with respect to each other in a rotation axis 18. In addition, on the adapter element 16 on the wiper blade side, connecting pieces 19 can be seen for supplying the wiper blade 10 with the washing fluid. It can be seen in FIG. 3 that the connecting pieces 19 are connected via two further connecting pieces 20 with a hose line 21, which in turn is coupled with a hydraulic mating plug 22. The hydraulic mating plug 22, which carries a seal 23 on its outer periphery, by insertion into the hydraulic connecting piece 14 is able to be connected with the latter hydraulically. The connecting or respectively separating of the hydraulic connecting piece 16 with or respectively from the hydraulic mating plug 22 takes place here in the direction of the double arrow 24, wherein the alignment of the double arrow 24 corresponds to the mounting or respectively dismantling direction of the wiper blade 10 with respect to the wiper arm 1.

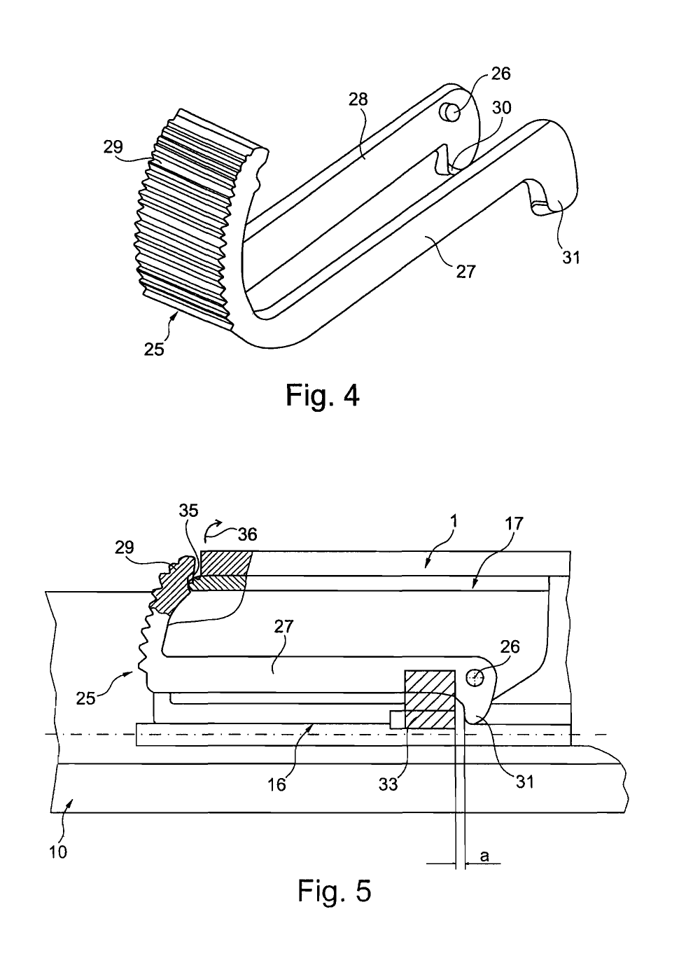

As can best be seen from viewing FIGS. 2 to 5 together, an auxiliary element for releasing the wiper arm 1 from the wiper blade 10 is arranged on the wiper arm 1. The auxiliary element is constructed here as a pivoted lever 25, which engages via two pin-like extensions (see FIG. 4), of which only one extension 26 can be seen in FIG. 4, into corresponding openings or respectively bores of the wiper arm 1. The extensions 26 form at the same time the pivot axis of the pivoted lever 25. The pivoted lever 25 has two pivot arms 27, 28, which are arranged parallel to each other, and which on the side facing away from the extensions 26 lead into a shared hand grip 29, constructed in a curved shape, able to be grasped by an operator. On the side of the extensions 26 lying opposite the hand grip 29, the two pivot arms 27, 28 have short, bent, lever sections 30, 31.

In addition, with the aid of FIG. 2 it can be seen that the adapter element 17 on the wiper blade side has two flat support surfaces 33 on its end face facing the wiper arm 1, of which only one support surface 33 can be seen in FIG. 2. The support surface 33 is arranged or respectively formed here in the manner of an extension on the side face 34 of the adapter element 16 on the wiper blade side.

In the operating position of the wiper device 100, in which the wiper arm 1 is connected with the wiper blade 10, the pivoted lever 25 locked or respectively secured in accordance with FIG. 5 with the adapter element 17 on the wiper arm side in the region of the one end edge 35. Furthermore, with the aid of FIG. 5 it can be seen that a distance a is formed between the lever sections 30, 31 and the support surface 33. It is thereby possible that the adapter element 16 on the wiper blade side is pivotable to the adapter element 17 on the wiper arm side about a certain angle amount, in order to make possible an adaptation of the position of the wiper blade 10 in particular to the vehicle window on the operation of the wiper device 100.

To release the wiper blade 10 from the wiper arm 1, and hence also the mechanical connection between the hydraulic connecting piece 14 and the hydraulic mating plug 22, the wiper arm 1, together with the adapter element 17 on the wiper arm side, must be brought into the pivoted position illustrated in FIG. 2 with respect to the adapter element 16 on the wiper blade side or respectively to the remaining wiper blade 10. The pivoted lever 25 is then pivoted in accordance with the arrow 36, whereupon the lever sections 30, 31 arrive in operative connection with the support surfaces 33 on the adapter element 16 on the wiper blade side and in so doing press the adapter 11 axially out from the wiper arm 1 or respectively from the mount on the wiper arm 1. It is essential here in addition that this releasing is only possible when simultaneously the detent section 13 of the lever 12 is pressed downwards into the opening 4.

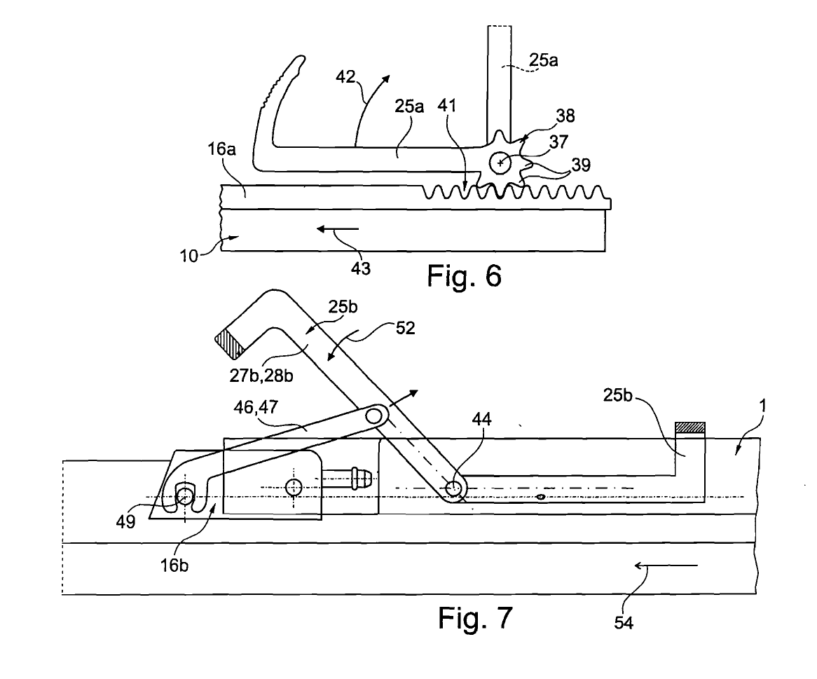

In FIG. 6 an alternative embodiment is illustrated of the pivoted lever 25a and of the wiper blade 10 in the region of the adapter element 16a on the wiper blade side, in which in addition the necessary mounting forces of the wiper blade 10 on the wiper arm 1 can be reduced. Here, the pivoted lever 25a is mounted in a rotation axis 37, wherein the pivoted lever 25a is constructed in the region of the rotation axis 37 in the form of a toothed wheel 38 with teeth 39. The teeth 39 engage into a support surface constructed as a toothing profile 41 of the adapter element 16a on the wiper blade side. By pivoting the pivoted lever 25a in the direction of the arrow 42, the teeth 39 roll in the toothing profile 41 and in so doing move the adapter element 16a on the wiper blade side in the direction of the arrow 43.

In FIG. 7 a further embodiment of the invention is illustrated, in which likewise, in addition to the reducing of the dismantling forces, the mounting forces for mounting the wiper blade 10 on the wiper arm 1 can be reduced. Here, the pivoted lever 25b is mounted in an axis 44 in the wiper arm 1. At a distance from the axis 44, on the pivot arms 27b, 28b bent levers 46, 47 are arranged, the end of which, facing away from the pivot arms 27b, 28b, engages into a transverse axis 49 arranged in the adapter element 16b on the wiper blade side, acting as a support surface. By pivoting the pivoted lever 25b in the direction of the arrow 52, the adapter element 16b on the wiper blade side is moved in the direction of the arrow 54, whereby likewise the hydraulic connecting piece 14 is separated from the hydraulic mating piece 22 (both not illustrated). In FIG. 7, in addition to the illustrated intermediate position of the pivoted lever 25b, the end position of the pivoted lever 25b is illustrated, in which the latter is aligned horizontally with the wiper blade 10. This end position corresponds to the operating position of the wiper blade 10.

The wiper blade 10 described so far, or respectively the pivoted levers 25, 25a and 25b, can be altered or respectively modified in a variety of ways, without deviating from the idea of the invention. However, it is essential that the pivoted lever 25, 25a, 25b in the form of a gear makes possible a power transmission for an operator, so that at least the necessary dismantling force for releasing the wiper blade 10 from the wiper arm 1 is reduced.

### LIST OF REFERENCE NUMBERS

1 wiper arm

2 wiper arm joint

3 bearing element

4 opening

6 hose line

10 wiper blade

11 adapter

12 lever

13 detent section

14 connecting piece

15 holder

16, 16a, 16b adapter element

17, 17b adapter element

18 rotation axis

19 connecting piece

20 connecting piece

21 hose line

22 mating plug

23 seal

24 double arrow

25, 25a, 25b pivoted lever

26 extension

27, 27b pivot arm

28, 28b pivot arm

29 hand grip

30 lever section

31 lever section

33 support surface

34 side face

35 end edge

36 arrow

37 rotation axis

38 toothed wheel

39 teeth

41 toothing profile

42 arrow

43 arrow

44 axis

46 bent lever

47 bent lever

49 transverse axis

52 arrow

54 arrow

100 wiper device

a distance

1-10. (canceled)

11. Wiper blade for cleaning windows of motor vehicles, with an adapter for fastening the wiper blade on a wiper arm, wherein the adapter consists of an adapter element; on a wiper arm side and of an adapter element on a wiper blade side, which are arranged so as to be pivotable with respect to each other, wherein the adapter element on the wiper blade side is connected together with the wiper arm via a detent connection, and wherein the adapter has at least one support surface for an auxiliary element, which serves for separating the adapter from the wiper arm.

12. Wiper blade according to claim 11, wherein the at least one support surface is arranged in the region of an end face of the adapter and is constructed as a flat surface.

13. Wiper blade according to claim 11, wherein the at least one support surface is constructed in the form of a toothing, into which a counter-toothing of the auxiliary element rolls.

14. Wiper blade according to claim 11, wherein the at least one support surface is constructed as an axis, into which the auxiliary element engages in a form-fitting manner.

15. Wiper blade according to claim 11, wherein the at least one support surface is arranged on the adapter element on the wiper blade side.

16. Wiper blade according to claim 11, wherein the adapter element on the wiper blade side has at least a first connection for the supply of a washing fluid, which first connection cooperates with a second connection arranged in the wiper arm, and wherein the first and second connections are arranged so as to be able to be coupled and respectively released by a linear movement.

17. Wiper blade according to claim 16, wherein an additional electrical connecting plug for a heating arrangement is arranged in the adapter element on the wiper arm side, which cooperates with a mating plug arranged in the wiper arm, and wherein the connecting plug and the mating plug are able to be coupled and respectively released by a linear movement.

18. Wiper arm for connecting with a wiper blade according to claims 11, wherein the wiper arm is releasably connected with the wiper blade via a detent connection, and wherein the auxiliary element is constructed as a pivoted lever which is pivotably mounted on the wiper arm and which, with a contact element for removing the wiper blade from the wiper arm, is arranged in operative connection with the at least one support surface.

19. Wiper arm according to claim 18, wherein the pivoted lever is constructed as a gear with a power transmission.

20. Wiper arm according to claim 18, wherein the pivoted lever is able to be locked in its one end position with the wiper arm or with the wiper blade.
